(19) United States
(12) Patent Application Publication
(10) Pub. No.: US 2012/0284961 A1
(43) Pub. Date: Nov. 15, 2012

(54) AIR KNIFE MODULE

(75) Inventors: Ying-Shu CHEN, Shindian (TW); Xiao-Gang ZHANG, Shenzhen City (CN); Bing YU, Shenzhen City (CN)

(73) Assignees: FIH (Hong Kong) Limited, Kowloon (HK); SHENZHEN FUTAIHONG PRECISION INDUSTRY CO., LTD., ShenZhen City (CN)

(21) Appl. No.: 13/284,677

(22) Filed: Oct. 28, 2011

(30) Foreign Application Priority Data
May 10, 2011 (CN) 201110119236.3

(51) Int. Cl. B08B 5/02

(52) U.S. Cl. 15/405

(57) ABSTRACT

An apparatus includes a main body and an air knife module mounted in the main body. The air knife module includes a first air knife assembly comprising a number of first air knives and a second air knife assembly comprising a number of second air knives. Each second air knife is staggered relative to the first air knife.

### CROSS-REFERENCE TO RELATED APPLICATIONS

This application is one of the four related co-pending U.S. patent applications listed below. All listed applications have the same assignee and were concurrently filed herewith. The disclosure of each of the listed applications is incorporated by reference into all the other listed applications.

| Attorney Docket No. | Title | Inventors |
|---|---|---|
| US39180 | AIR KNIFE MODULE | Chen et al. |
| US39181 | NOZZLE ASSEMBLY FOR SPRAY | Chen et al. |
| | APPARATUS | |
| US39182 | AIR DRYING APPARATUS | Chen et al. |
| US39183 | CLEANING AND DRYING | Chen et al. |
| | APPARATUS | |

BACKGROUND

1. Technical Field

The present disclosure generally relates to air knives, and particularly to an air knife module and an apparatus with the air knife module.

2. Description of Related Art

Devices that produce air curtains such as air knives are used in a variety of different applications for cleaning and drying purposes. For example, an air knife can be used to blow dirt and other debris off objects such as parts or sheets. An air knife can also be used to help cool or dry such objects.

However, conventional air knifes are positioned opposite to each other in the cleaning and drying apparatus. The knife edge of the air knifes are aligned with each other. When the air knifes eject pressurized air to two sides of the products traveling on conveyors, the air from each air knife is easily counteracted by air from an opposite air knife and therefore wastes energy.

Therefore, there is room for improvement within the art.

### BRIEF DESCRIPTION OF THE DRAWINGS

Many aspects of the air knife module can be better understood with reference to the following drawings. The components in the drawings are not necessarily to scale, the emphasis instead being placed upon clearly illustrating the air knife module. Moreover, in the drawings, like reference numerals designate corresponding parts throughout the several views.

FIG. 1 is a schematic view of an apparatus including an air knife module according to an exemplary embodiment.

FIG. 2 is a cross-sectional view of the apparatus taken along line II-II of FIG. 1.

FIG. 3 is a schematic view of an air knife of the air knife module in FIG. 1.

FIG. 4 is a cross-sectional view of the air knife taken along line IV-IV of FIG. 3.

### DETAILED DESCRIPTION

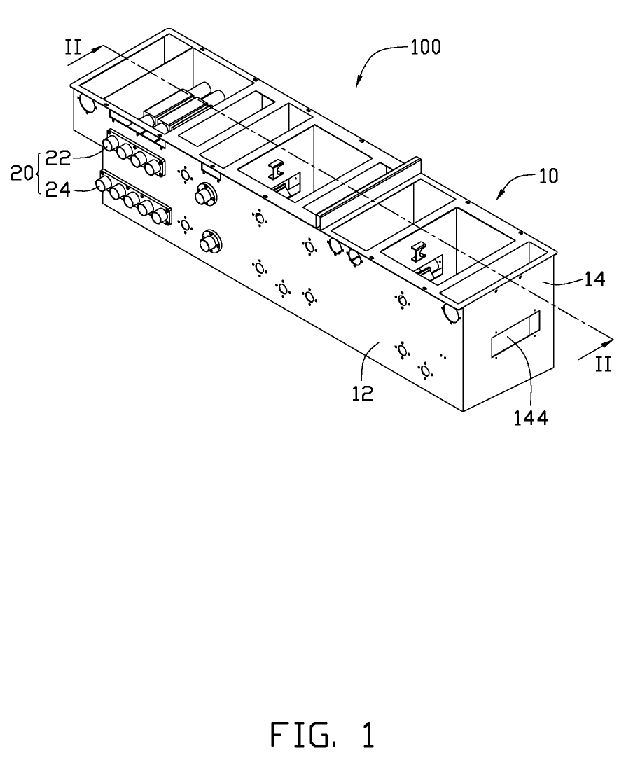

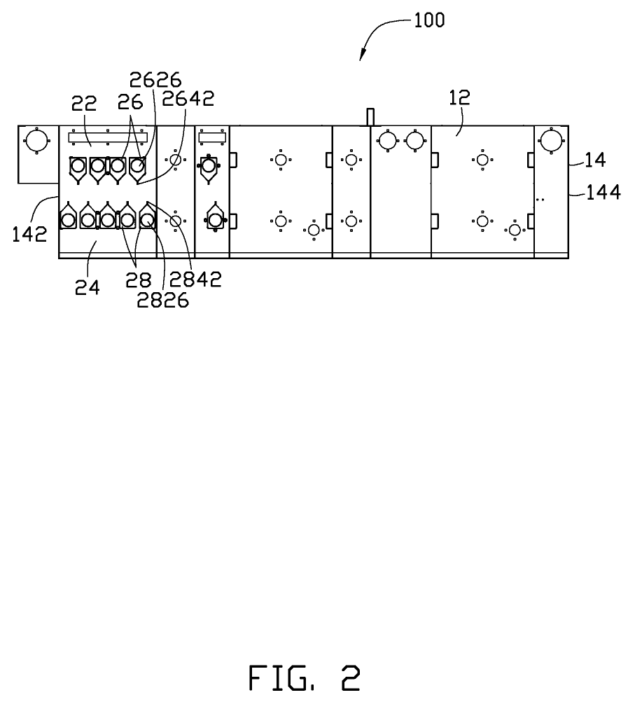

FIGS. 1 and 2 show an exemplary embodiment of an apparatus 100. The apparatus 100 includes a main body 10 and an air knife module 20 mounted in the main body 10. The illustrated air knife module 20 produces a number of air curtains that can be used, for example, to clean, cool or dry products. The air knife module 20 can also be used in other applications and the present disclosure should not be limited to any particular application.

Referring to FIG. 2, the main body 10 includes opposite sidewalls 12 and opposite end walls 14. The air knife module 20 is mounted on the sidewalls 12. One of the end walls 14 defines an entrance 142, and the other end wall 14 defines an exit 144. The products traveling on conveyors are driven to enter from the entrance 142, blown off by the air knife module 20, and exit through the exit 144.

The air knife module 20 includes a first air knife assembly 22 and a second air knife assembly 24. The first air knife assembly 22 and the second air knife assembly 24 are mounted between the sidewalls 12.

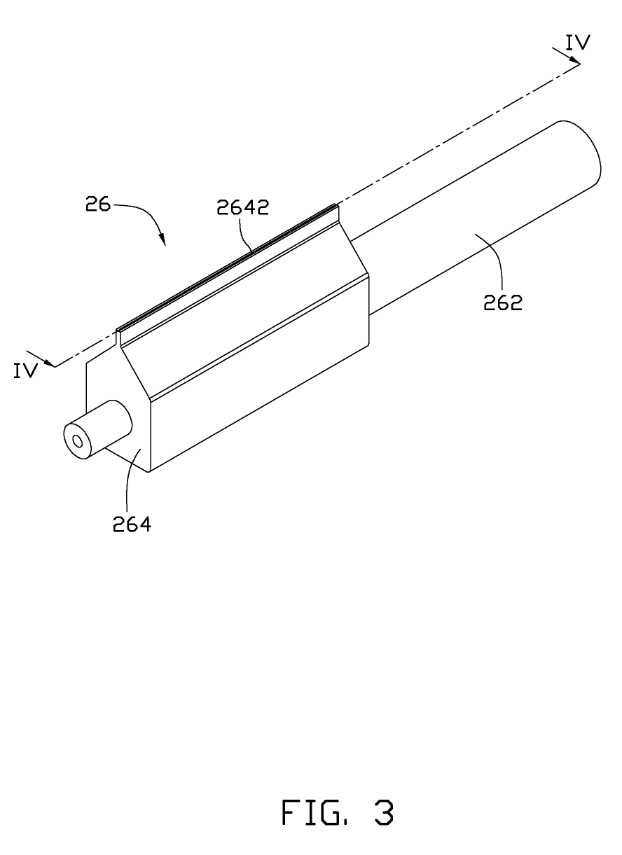

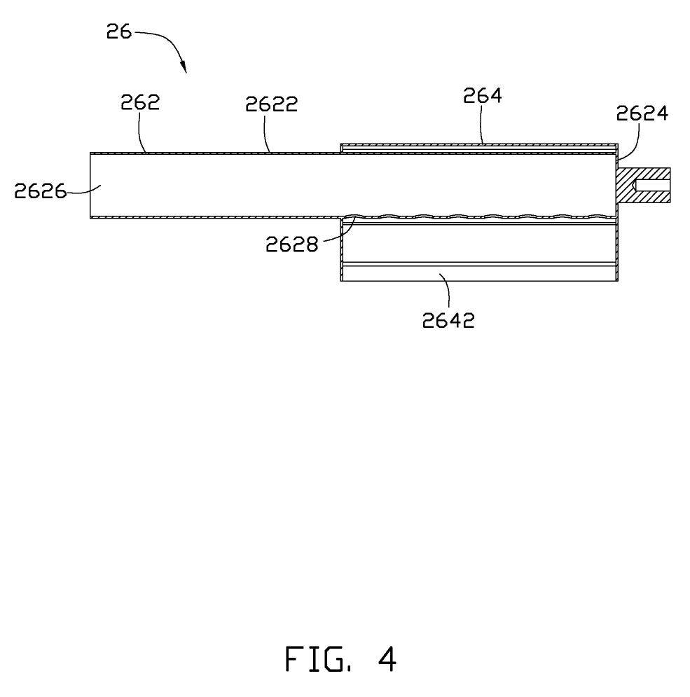

The first air knife assembly 22 is comprising a number of first air knives 26. In the exemplary embodiment, there are four first air knives 26 arranged along a line to constitute the first air knife assembly 22. Referring to FIGS. 3 and 4, each first air knife 26 includes a pipe 262 and an elongated housing 264 fitted around the pipe 262. The pipe 262 includes a peripheral wall 2622 and a connecting end 2624. One end of the peripheral wall 2622, opposite to the connecting end 2624, has an air inlet 2626 configured to connect to a supply of compressed air. The peripheral wall 2622 defines a number of air outlets 2628 arranged along a line. The connecting wall 2624 is mounted to the housing 264. The elongated housing 264 is a hollow shell, and one side necks down to a narrow gap 2642 that extends along the length of the housing 12. The narrow gap 2642 communicates with the air outlets 2628 so that compressed air can exit from the air outlets 2628 and the gap 2642 to form an air curtain.

The second air knife assembly 24 is comprising a number of second air knives 28. In this exemplary embodiment, there are five second air knives 28 to constitute the second air knife assembly 24. The structure of each second air knife 28 is similar to the first air knife 26. Each second air knife 28 includes an air inlet 2826 and a narrow gap 2862. All of the air outlets 2862 of the second air knives 28 are staggered relative to the air outlets 2642 of the first air knives 26.

In use, the air outlets 2626, 2826 of the first air knife assembly 22 and the second air knife assembly 24 are connected to the supply of compressed air (not shown). The products traveling on conveyors (not shown) are driven to enter from the entrance 142, and the first air knife assembly 22 and the second air knife assembly 24 are activated. The first air knife assembly 22 and second air knife assembly 24 blow off two sides of the products through the gaps 2642, 2862. Since the gaps 2642, 2862 are staggered, the air from two air knife assemblies 22, 24 may reduce counteraction and effectively utilize energy. After the products are cleaned or dried, the products traveling on conveyors are driven to exit through the exit 144.

It is to be understood, however, that even through numerous characteristics and advantages of the present disclosure have been set forth in the foregoing description, together with details of the structure and function of the disclosure, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. An air knife module comprising:
a first air knife assembly comprising a number of first air knives; and
a second air knife assembly comprising a number of second air knives;
wherein each second air knife is staggered relative to the first air knife.

2. The air knife module as claimed in claim 1, wherein each of the first air knives and the second air knives includes a pipe and an elongated housing, and the elongated housing is fitted around the pipe.

3. The air knife module as claimed in claim 2, wherein the pipe includes a peripheral wall and a connecting end, one end of the peripheral wall opposite to the connecting end has an air inlet configured for being connected to a supply of compressed air.

4. The air knife module as claimed in claim 3, wherein the peripheral wall defines a number of air outlets arranged along a line, the connecting wall is mounted to the elongated housing.

5. The air knife module as claimed in claim 4, wherein the elongated housing is a hollow shell, and one side necks down to a narrow gap that extends along the length of the housing, and the narrow gap communicates with the air outlets.

6. An apparatus for cleaning and drying, comprising:
a main body;
an air knife module mounted in the main body, the air knife module including a first air knife assembly comprising a number of first air knives and a second air knife assembly comprising a number of second air knives; wherein each second air knife is staggered relative to the first air knife.

7. The apparatus as claimed in claim 6, wherein each of the first air knives and the second air knives includes a pipe and an elongated housing, and the elongated housing is fitted around the pipe.

8. The apparatus as claimed in claim 7, wherein the pipe includes a peripheral wall and a connecting end, one end of the peripheral wall opposite to the connecting end has an air inlet configured for being connected to a supply of compressed air.

9. The apparatus as claimed in claim 8, wherein the peripheral wall defines a number of air outlets arranged along a line, the connecting wall is mounted to the elongated housing.

10. The apparatus as claimed in claim 9, wherein the elongated housing is a hollow shell, and one side necks down to a narrow gap that extends along the length of the housing, and the narrow gap communicates with the air outlets.
